(19) United States
(12) Patent Application Publication
(10) Pub. No.: US 2009/0183410 A1
(43) Pub. Date: Jul. 23, 2009

(54) Customizable, double-sided adhesive information label

(75) Inventors: Dennis J. Tursso, Sunfish Lake, MN (US); Bruce Rankin, Inver Grove Heights, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Tursso Companies, Inc., St. Paul, MN (US)

(21) Appl. No.: 12/009,881

(22) Filed: Jan. 23, 2008

(51) Int. Cl. G09F 3/10; B32B 37/12

(52) U.S. Cl. 40/638; 156/227

(57) ABSTRACT

An adhesive label comprises a substrate having a first side and a second side. The first side includes printed information, and the second side includes an adhesive coating. The substrate is shaped such that a front cover portion of the substrate is foldable to be alongside a back cover portion of the substrate to leave a hinge portion of the second side exposed along a first edge of the substrate and a fastener portion of the second side exposed along a second edge of the substrate. In one embodiment of the invention, the adhesive label includes a backing layer disposed between the front cover portion and the back cover portion, wherein the backing layer includes a tab extending beyond an outer periphery of the front cover portion near the fastener portion.

### BACKGROUND

This invention relates to adhesive information labels, and in particular to double-sided labels suitable for use with prescription drug bottle.

When a prescription for a drug is filled at a pharmacy or some other such place, general information relating to a patient is taken by a pharmacist to fill the prescription. For example, the general information includes the name of the patient, the name of the prescription drug, the names of other drugs taken by the patient and medical conditions of the patient. The pharmacist uses the general information to generate specific information for the patient relating to the prescribed drug. For example, the pharmacist would generate instructions relating to the proper dosage, indications for when to use the drug, contraindications for when not to use the drug, drug interaction information, side effects from using the drug and any other warnings relating to usage of the drug. Some or all of the general and specific information is recorded and conveyed to the patient on a variety of written mediums such that the patient can refer to the information at a later time.

Some of the general and specific information relating to a patient's prescription is often recorded on the outside of labels affixed to prescription drug bottles. Pharmacies typically retain a supply of new unlabeled bottles and blank labels onto which some of the information can be imprinted using a small, office-sized printer. Prescription drug bottles typically comprise small, cylindrical bottles into which a pharmacist places a short supply of prescription drugs at the time the prescription is filled. The labels typically comprise small sheets of paper having an adhesive backing such that the label can be fed through a printer and then affixed to a side of the bottle. Thus, printable labels provide pharmacists with a simple and fast medium for conveying customized information to patients at the time prescriptions are filled. The size of the bottles, however, typically only allows for basic information concerning the drug and patient, such as the names of the patient and the drug, to be included on the label. Further instructions relating to indications, contraindications and warnings thus need to be supplied to the patient on an additional medium. For example, pharmacists often hand-write information on the sides of small paper bags into which the prescription bottles are placed. However, information supplied on such supplemental mediums often ends up being unused by the patient. For example, hand written notes are often illegible, and supplemental bags or papers are often lost or thrown away. Patients are then frequently left without critical information that has the potential for affecting the health and well-being of the patient. Patients are thus left to call upon the pharmacy or pharmacist from which they obtained the prescription to reacquire the lost information. There is, therefore, a need for a product information label that provides pharmacists with a way to permanently include general and specific customized information concerning individual patients with the prescription bottle at the time the prescription is filled.

### SUMMARY

The present invention is directed to a customizable, double-sided adhesive label for use with, among other things, prescription drug bottles. The adhesive label comprises a substrate having a first side and a second side. The first side includes printed information, and the second side includes an adhesive coating. The substrate is shaped such that a front cover portion of the substrate is foldable to be alongside a back cover portion of the substrate to leave a hinge portion of the second side exposed along a first edge of the substrate and a fastener portion of the second side exposed along a second edge of the substrate. In one embodiment of the invention, the adhesive label includes a backing layer disposed between the front cover portion and the back cover portion, wherein the backing layer includes a tab extending beyond an outer periphery of the front cover portion near the fastener portion.

### BRIEF DESCRIPTION OF THE DRAWINGS

FIG. 1 shows a front view of a customizable, double-sided adhesive information label of the present invention in a pre-deployed state.

FIG. 2 shows a conceptual longitudinal cross-sectional view of the information label taken at section 2-2 of FIG. 1.

FIG. 3 shows a front view of a customizable, double-sided adhesive information label of the present invention in a post-deployed state.

FIG. 4 shows a conceptual longitudinal cross-sectional view of the information label taken at section 4-4 of FIG. 3.

FIG. 5 shows a conceptual transverse cross-sectional view of the information label taken at section 5-5 of FIG. 3.

FIG. 6 shows a prescription drug bottle having a customizable, double-sided adhesive information label of the present invention opened such that a front cover portion is viewable.

FIG. 7 shows a prescription drug bottle having a customizable, double-sided adhesive information label of the present invention opened such that a back cover portion is viewable.

### DETAILED DESCRIPTION

FIG. 1 shows a front view of customizable, double-sided adhesive information label 10 of the present invention in a pre-deployed state. Information label 10 comprises substrate 12, which is adhered to backing 14. Information label 10 comprises one of a plurality of information labels that are arranged in sheet form or roll form such that they can be fed into a printer. For example, backing 14 could be side-by-side with other backings and connected at perforations to form a roll. Sheets or rolls of information label 10 can be manufactured in bulk at the wholesale level having some amount of pre-printed information on substrate 12, such as a pharmacy name and trademark. The sheets or rolls can subsequently be fed through a local printer at the retail level such that each individual label 10 can be imprinted with customized information concerning an end-user or patient. For example, a roll of information labels 10 could be printed upon using a thermal printer as is commonly found in a pharmacist's office or drug store, or a sheet of information labels 10 could be printed by any commercially available laser printer. After having undergone a local printing process, all or portions of backing 14 can be removed from substrate 12 such that information label 10 can be affixed to an object or product, such as a prescription drug bottle. In particular, substrate 12 can be configured, after removal from backing 14, such that information printed on the front of substrate 12 is positioned on the front and back side of information label 10. Substrate 12 is also configured such that label 10 can be adhered to the prescription drug bottle to function in a hinge-like manner such that both sides of information label 10 is accessible. FIG. 1 shows information label 10 in the wholesale manufactured state, ready to be printed upon by a retail printer before being adhered to a prescription drug bottle and used by an end user.

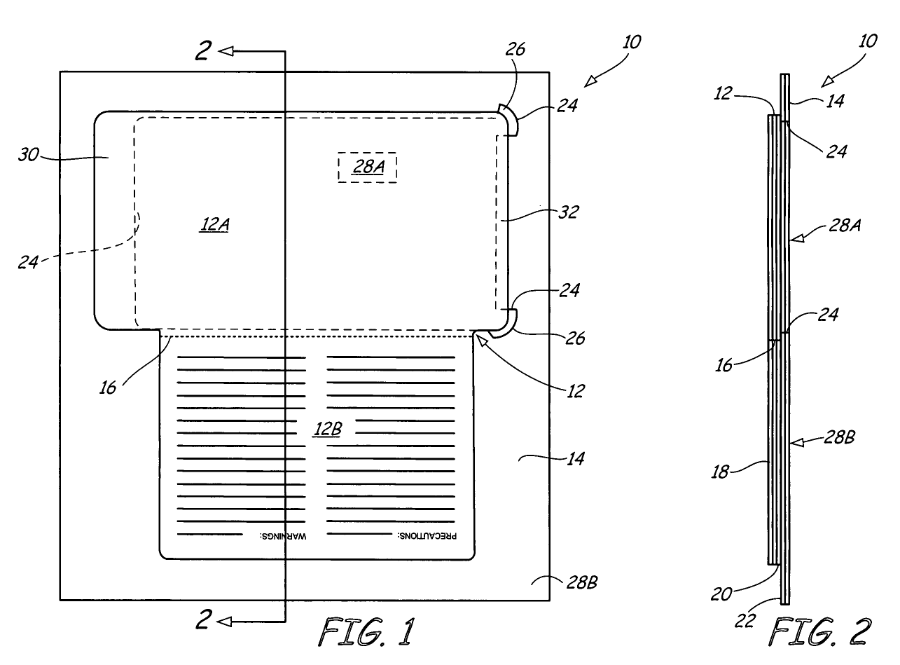

FIG. 2 shows a conceptual longitudinal cross-sectional view of customizable adhesive information label 10 taken at section 2-2 of FIG. 1. Information label 10 includes substrate 12 and backing 14. Substrate 12 includes perforation 16, print layer 18 and adhesive layer 20. Backing 14 includes release layer 22 and die-cut 24. Substrate 12 comprises a sheet of paper, plastic or some other such material that provides a durable medium having a surface suitable for printing. Print layer 18 comprises various chemicals as are used in typical printing processes, such as inks, primers and varnishes. Adhesive layer 20 comprises any suitable adhesive as is used in the adhesive label industry. For example, in one embodiment, adhesive layer 20 comprises an acrylic pressure sensitive adhesive. Perforation 16 comprises a series of small slits extending through substrate 12 to facilitate folding of substrate 12. Backing 14 comprises a sheet of paper, plastic or any other suitable material suitable for providing a medium for release layer 22 that is easily peeled back from or otherwise removed from adhesive layer 20. Release layer 22 comprises any suitable release layer as is used in the adhesive label industry. For example, in one embodiment, release layer 22 comprises an ultraviolet release coating. Die cut 24 comprises a continuous insertion extending through backing 14 and release layer 22 such that when substrate 12 is removed from backing 14, a portion of backing 14 stays secured to adhesive layer 20.

Returning to FIG. 1, substrate 12 includes front cover portion 12A, back cover portion 12B and perforation 16. Backing 14 includes die cut 24, which is shaped to produce tab 26 and reinforcement portion 28A. In the pre-deployed state, substrate 12 and backing 14 comprise generally flat and parallel sheets of material bound together by adhesive layer 20 such that information label 10 can be fed through a printer. Backing 14 covers the entirety of adhesive layer 20 such that adhesive layer 20 does not interfere with the cycling of label 10 through a printer. Additionally, in the pre-deployed state, front cover portion 12A and back cover portion 12B comprise the same continuous outer surface of substrate 12. Specifically, front cover portion 12A and back cover portion 12B are located in the same plane on top of substrate 14 such that when fed through a printer, they both face the same printing head or apparatus. As such, front cover portion 12A and back cover portion 12B can be simultaneously printed upon by a single-sided printing process such as from a laser or thermal printer. In the embodiment shown, front cover portion 12A and back cover portion 12B comprise different sized rectangles that share one side approximately along perforation 16. As such, the periphery of substrate 12 defines an irregular shape. The periphery of backing 14 is larger than substrate 12 and defines a printer-friendly shape, such as a rectangle, such that information label 10 can be easily fed through a printer.

Die cut 24 encircles an area of backing 14 that is smaller than front cover 12A to form reinforcement portion 28A, leaving excess portion 28B surrounding reinforcement portion 28A. Die cut 24 also forms tabs 26 that extend from reinforcement portion 28A. Front cover portion 12A is positioned on backing 14 to cover reinforcement portion 28A such that tabs 26 extend beyond the perimeter of front cover portion 12A. Front cover portion 12A and back cover portion 12B are adjacent each other along perforation 16. Front cover portion 12A covers a larger surface area than back cover portion 12B. Back cover portion 12B is narrower than front cover portion 12A and reinforcement portion 28A. Specifically, reinforcement portion 28A is narrower than front cover portion 12A such that hinge portion 30 and fastener portion 32 are formed at the sides of front cover portion 12A. Back cover portion 12B is, however, approximately the same height as front cover portion 12A. In other embodiments, back cover portion 12B is taller than front cover portion 12A such that back cover portion 12B can be folded into a multi-panel fold-out booklet. For example, in one embodiment, back cover portion 12B is approximately three times taller than front cover portion 12A. As such, back cover portion 12B can be folded into thirds arranged in a z-shaped pattern to form a double-sided pamphlet page that folds out from behind front cover portion 12A. The specific size of front cover portion 12A and back cover portion 12B can be varied based on design needs. For example, smaller or larger sized labels can be produced for use with smaller or larger prescription drug bottles.

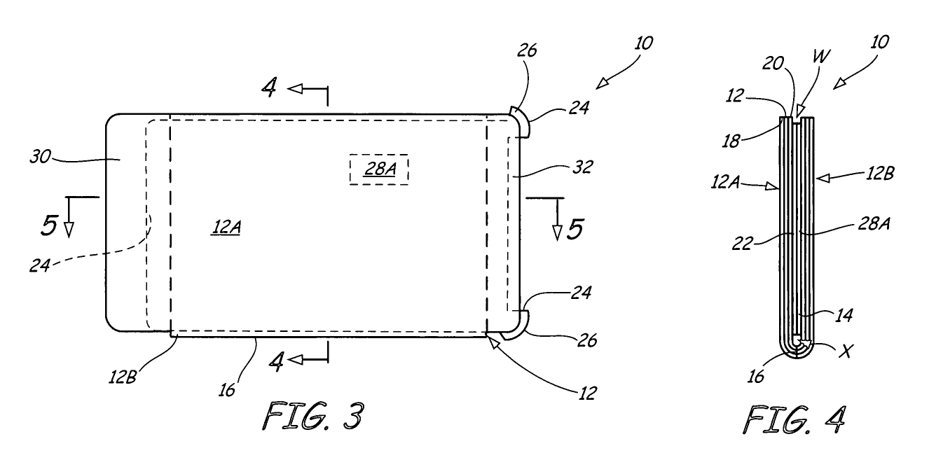

After information label 10 is fed through a printer, substrate 12 can be peeled off of backing 14, leaving reinforcement portion 28A and tabs 26 affixed to adhesive layer 20 on the back of front cover portion 12A. Expendable portion 28B is discarded. Front cover portion 12A extends beyond the top and sides of reinforcement portion 28A, while back cover portion 12B extends beyond the bottom of reinforcement portion 28A. Tabs 26, however, extend beyond the perimeter of front cover portion 12A to provide a means for grasping front cover portion 12A. Hinge portion 30 and fastener portion 32 comprise vertical bands of front cover portion 12A that extend beyond reinforcement portion 28 such that strips of adhesive layer 20 are exposed at the left and right side of front cover portion 12A. The top edge portion of front cover portion 12A is also left with an exposed portion of adhesive layer 20 such that back cover portion 12B can be folded back at perforation 16 to be joined with front cover portion 12A, as shown in FIG. 3.

FIG. 3 shows a front view of customizable, double-sided adhesive information label 10 of the present invention in a post-deployed state. Information label 10 includes substrate 12 and backing 14. Substrate 12 includes front cover portion 12A, back cover portion 12B, perforation 16, hinge portion 30 and fastener portion 32. Backing 14 includes die cut 24, tabs 26 and reinforcement portion 28A. Substrate 12 is removed from backing 14 such that reinforcement portion 28A and tabs 26 are left adhered to substrate 12, while expendable portion 28B (FIG. 1) is discarded. Substrate 12 is folded at perforation 16 such that the majority of back cover portion 12B is concealed under front cover portion 12A and adhesive layer 20 is left exposed only near hinge portion 30 and fastener portion 32.

FIG. 4 shows a conceptual longitudinal cross-sectional view of information label 10 taken at section 4-4 of FIG. 3. Back cover portion 12B of substrate 12 is folded behind front cover portion 12A at perforation 16. The heights of back cover portion 12B and front cover portion 12A are approximately equal such that the top edge of front cover portion 12A aligns with the bottom edge of back cover portion 12B when folded at perforation 16. In other words, perforation 16 is positioned approximately halfway between the top edge of front cover portion 12A and the bottom edge of back cover portion 12B. Reinforcement layer 18 is shorter than front cover portion 12A and back cover portion 12B such that portions of adhesive layer will abut each other when substrate 12 is folded. As indicated by arrow W, the portion of adhesive layer 20 at the bottom edge of back cover portion 12B and the portion of adhesive layer 20 at the top edge of front cover portion 12A will bend around reinforcement portion 28A toward each other when label 10 is applied to a surface. Thus, reinforcement portion 28A is locked in along its top edge. Likewise, adhesive layer 20 opposes itself at the bottom of reinforcement portion 28A, as indicated at arrow X, such that bulges are prevented from forming at perforation 16, and reinforcement portion 28A is locked in along its bottom edge. The portion of adhesive layer 20 on back cover portion 12B also adheres to the side of reinforcement layer 28A not covered by release layer 22. Thus, reinforcement portion 28A is layered between front cover portion 12A and back cover portion 12B. Reinforcement portion 28A is narrower than front cover portion 12A, but wider than back cover portion 12B such that the portions of adhesive layer 20 at hinge portion 30 and fastener portion 32 are exposed.

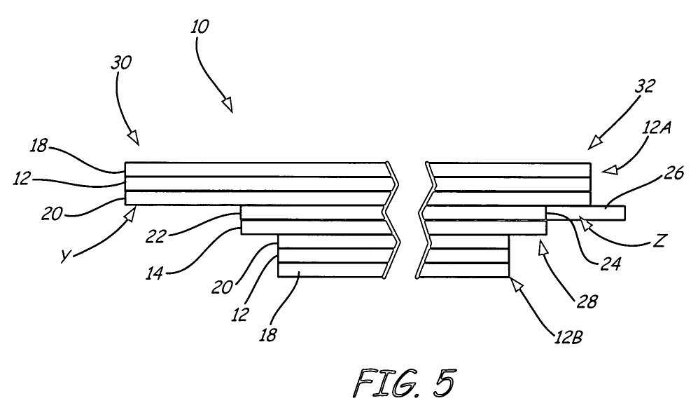

FIG. 5 shows a conceptual transverse cross-sectional view of information label 10 taken at section 5-5 of FIG. 3. Reinforcement portion 28 is sandwiched between front cover portion 12A and back cover portion 12B. Back cover portion 12B is disposed between the side edges of reinforcement portion 28A. The portion of adhesive layer 20 on back cover portion 12B is adhered to the backside of backing 14, the side without release material 22. Thus, back cover portion 12B is non-releasably affixed to reinforcement portion 28A. Front cover portion 12A extends beyond the sides of reinforcement portion 28A to form hinge portion 30 and fastener portion 32. As indicated at arrow Y, hinge portion 30 comprises a portion of adhesive layer 20 exposed along the inside of front cover portion 12A such that label 10 can be affixed to a surface of an object such as a prescription bottle. As shown at arrow Z, fastener portion 32 comprises a portion of adhesive layer 20 exposed along the inside of front cover portion 12A such that label 10 can be attached and released from the surface of the prescription bottle. When label 10 is applied to a surface, hinge portion 30 and fastener portion 32 bend around reinforcement portion 28 and back cover portion 12B to engage the prescription bottle surface. Tabs 26 extend from under front cover portion 12A such that fastener portion 32 can be pulled up from the prescription bottle surface. The widths of hinge portion 30 and fastener portion 32 are determined by the width of reinforcement portion 28. In other embodiments, back cover portion 12B can extend beyond the width of reinforcement portion 28 to control the widths of hinge portion 30 and fastener portion 32. The widths of hinge portion 30 and fastener portion 32 assist in determining the strength to which substrate 12 will be adhered to the prescription bottle.

Returning to FIG. 3, hinge portion 30 is typically wider than fastener portion 32 such that hinge portion 30 provides greater adhesive strength than fastener portion 32. The bonding strengths of hinge portion 30 and fastener portion 32 depend on the composition of adhesive layer 20 and the areas of hinge portion 30 and fastener portion 32, respectively. Hinge portion 30 affixes the left side of label 10 to a surface such that label 10 cannot be removed easily, while fastener portion 32 affixes the right side of label 10 to the surface such that label 10 can be more easily removed. Hinge portion 30 comprises a band of adhesive layer 20 that spans the height of front cover portion 12A to secure the left-most edge of label 10 to a prescription bottle. Fastener portion 32 comprises a band of adhesive layer 20 that is disposed on the right-most edge of label 10 between tabs 26. The required sizes and strengths of hinge portion 30 and fastener portion 32 are determined based on, among other factors, the size and weight of front cover portion 12A, back cover portion 12B and reinforcement portion 28A.

In various embodiments of the invention, reinforcement portion 28A assists in retaining curvature of front cover portion 12A such that label 10 remains better attached to the prescription bottle surface. Reinforcement portion 28A is comprised of a material that gives front cover portion 12A and back cover portion 12B a memory for the curvature of a prescription drug bottle. For example, after substrate 12 is removed from backing 14, front cover portion 12A, reinforcement portion 28A and back cover portion 12B comprise flat, parallel layers. After being label 10 is affixed to a curved surface such as that of a bottle, front cover portion 12A, reinforcement portion 28A and back cover portion 12B comprise concentrically curved layers. Adhesive layer 20 on front cover portion 12A is affixed to release layer 22 on reinforcement portion 28A. Release layer 22 permits adhesive layer 20 to slide along reinforcement portion 28A such that front cover portion 12A can adjust to a larger radius of curvature than reinforcement portion 28A. Thus, reinforcement portion 28A and front cover portion 12A are held together in a concentric shape about the bottle as cover portion 12A imposes the same general curvature as the prescription bottle into reinforcement portion 28A.

Tabs 26 extend from reinforcement portion 28A across adhesive layer 20 on fastener portion 32 to reduce the effective size of fastener portion 32 and to prevent the corners of fastener portion 32 from adhering to the prescription bottle surface. Tabs 26 also extend beyond front cover portion 12A to form small flaps that can be grasped to facilitate pulling front cover portion 12A from the prescription bottle to break the adhesive bond formed by adhesive layer 20. Tabs 26 are connected with reinforcement portion 28 to prevent tabs 26 from separating from front cover portion 12A. Tabs 26 are separable from front cover portion 12A due to being adjacent release layer 20. Reinforcement portion 28 is, as previously described, entrapped between front cover portion 12A and back cover portion 12B. As such, reinforcement portion 28 provides an anchor to tabs 26. Reinforcement portion 28 need not extend completely over to hinge portion 30 to provide support to tabs 26. In another embodiment, reinforcement portion 28 is omitted and back cover portion 12B provides reinforcement to tabs 26. In another embodiment, reinforcement portion 28 and tabs 26 are omitted entirely. In any embodiment, however, back cover portion 12B is folded alongside front cover portion 12A such that hinge portion 30 and fastener portion 32 are formed to produce a double-sided label that can be attached to, among other things, a prescription drug bottle in a pull-open, hinged fashion.

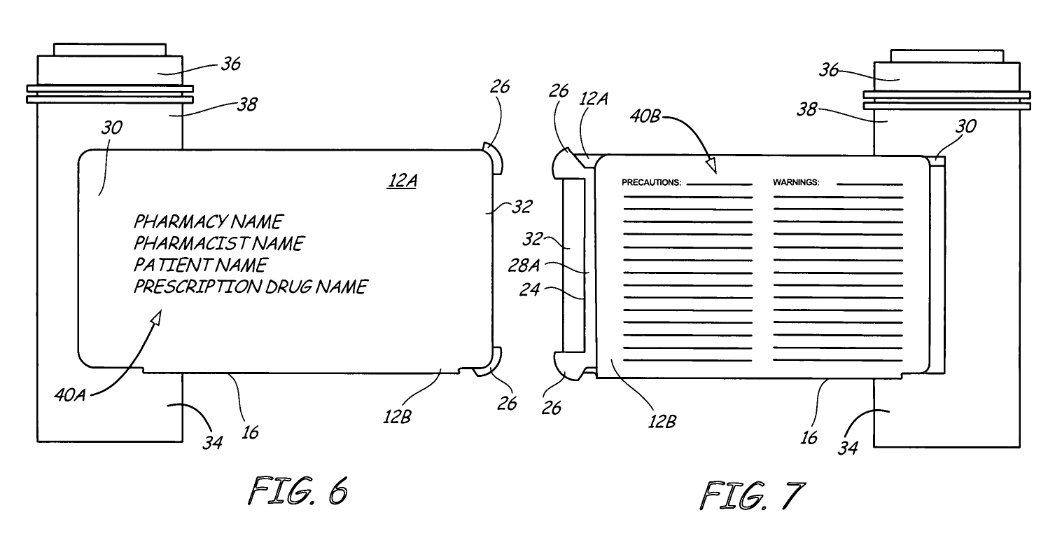

FIG. 6 shows customizable, double-sided adhesive label 10 of the present invention affixed to prescription drug bottle 34 at hinge 30 such that printed indicia 40A on front cover portion 12A are viewable. Prescription drug bottle 34, which includes cap 36, comprises a generally cylindrical container into which small prescription drugs in the form of pills or tablets can be placed. Bottle 34 includes a closed bottom end and an open top end, between which is disposed annular side wall 38. Adhesive label 10 is affixed to the outside of sidewall 38 at hinge portion 30. Front cover portion 12A is extended such that indicia 40A imprinted on the outside of front cover portion 12A are accessible. In the embodiment shown, indicia 40A comprise information relating to a specific patient and drug prescription. For example, the names of the pharmacy, pharmacist, patient and drug are imprinted onto front cover portion 12A. Some portions of indicia 40A are printed onto label 10 at the bulk or wholesale production level of labels 10. For example, the pharmacy name is printed onto front cover portion 12A of all labels 10 in a roll or sheet. Some portions of indicia 40A relate to customized information for specific pharmacists and patients, for example, and are printed onto cover 12A at the local or retail level. Front cover portion 12A can be wrapped around the exterior of sidewall 38 such that fastener portion 32 can be affixed to the exterior of sidewall 38. Tabs 26 extend from under front cover portion 12A to provide a means for facilitating release of fastener portion 32 from sidewall 38. In such a closed state, label 10 is affixed to the outside of sidewall 38 similar to that of a conventional one-sided label. As such, label 10 is tightly wound around bottle 34 in a compact manner such that bottle 34 can be conveniently stowed away or stored, yet front cover portion 12A is still viewable. When it is desirable to view information printed on the inside of label 10, tabs 26 can be lifted to access back cover portion 12B.

FIG. 7 shows customizable, double-sided adhesive label 10 of the present invention affixed to prescription drug bottle 34 at hinge 30 such that indicia 40B on back cover portion 12B are viewable. Fastener portion 32 is released from sidewall 38, and label 10 is bent at hinge portion 30, along the edge of reinforcement portion 28A, such that back cover portion 12B is viewable on the inside of label 10. Substrate 12 is folded at perforation 16 such that back cover portion 12B is generally parallel or concentric with front cover portion 12A. Reinforcement portion 28A is disposed between front cover portion 12A and back cover portion 12B to provide support to tabs 26 and add rigidity and curvature to front cover portion 12A, among other functions. Tabs 26 cover the corners of fastener portion 32, which prevents the corners of front cover portion 12A from becoming crinkled or dog-eared. Tabs 26 also reduce the size of adhesive layer 20 exposed along fastener portion 32, and facilitate release of fastener portion 32 from sidewall 38. The size, number, location and shape of tabs 26 vary depending on design needs. For example, in one embodiment, a single rectangular tab is placed centrally between the top and bottom edges of fastener portion 32. In other embodiments, no tabs are used.

With label 10 opened, printed indicia 40B are viewable on back cover portion 12B. In the embodiment shown, indicia 40B comprise customized information relating to the specific patient and prescription drug, such as warnings, instructions, interactions, indications or precautions. Portions of indicia 40B can be printed onto label 10 at the bulk or wholesale level, such as headings or blank lines, while portions of indicia 40B relating to customized information for a specific patient are printed onto back cover 12B at the local or retail level. In other embodiments, however, information concerning the specific patient is not indicated, and other promotional information, such as advertisements or coupons, is printed at the wholesale or retail level in place of warnings or instructions. Furthermore, with label 10 in the open position, any foldout panels extending from back cover portion 12B can be extended to expose any further printed indicia. After information on back cover portion 12B has been viewed and accessed, label 10 can be closed again by bending front cover portion 12A at hinge portion 30 such that fastener portion 32 again contacts sidewall 38. Adhesive layer 20 and sidewall 38 interact such that label 10 can be repeatedly opened and closed by detaching and reattaching fastener portion 32 to sidewall 38 as it is desired to access information on back cover portion 12B.

Adhesive label 10 of the present invention provides an information label that provides additional surface area for the imprinting of customized information relating to an end-user at the retail level, such as a patient at a pharmacy. Adhesive label 10 is easily printed upon using a standard, single sided printer, such that double-sided printing or flipping of the label during the printing process is not necessary. Information label 10 is easy to shape or fold at the retail level after printing. In the embodiment shown, only one folding step is needed. Likewise, after assembled, information label 10 does not require folding of complex fold-out pamphlets. In some embodiments, simple fold out panels formed from back cover portion 12B are easily pulled out and tucked behind front cover portion 12A. Indicia 40A and 40B provided on front cover portion 12A and back cover portion 12B, respectively, are permanently attached to label 10 with hinge portion 30, making it inseparable from bottle 34. Fastener portion 32 and tabs 26 provide a means for easy, repeated opening and closing of label 10. Indicia 40A and 40B thus provide the patient with valuable, legible information relating to proper dosage and usage of the drug that is not easily lost. Thus, the patient is always informed of proper usage of the prescription drug and incidences requiring the patient to contact the pharmacy or pharmacist are reduced. Furthermore, liability exposure of the pharmacy, pharmacist and drug manufacturer is reduced.

Although the present invention has been described with reference to preferred embodiments, workers skilled in the art will recognize that changes may be made in form and detail without departing from the spirit and scope of the invention.

1. An adhesive label comprising:
a substrate comprising:
a first side including printed information; and
a second side including an adhesive coating;
wherein the substrate is shaped such that a front cover portion of the substrate is foldable along an edge to be positioned alongside and adhered to a back cover portion of the substrate to leave a hinge portion of the second side exposed along a first edge of the substrate and a fastener portion of the second side exposed along a second edge of the substrate.

2. The adhesive label of claim 1 wherein the front cover portion is parallel with the back cover portion.

3. The adhesive label of claim 1 wherein the front cover portion is concentric with the back cover portion.

4. The adhesive label of claim 1 and further comprising a single-ply backing layer configured to be disposed between and adhered to the adhesive coating along the front cover portion and the back cover portion when the substrate is folded along the edge.

5. The adhesive label of claim 4 and further comprising an integral tab extending from the backing layer beyond an outer periphery of the front cover portion and across a segment of the fastener portion such that a segment of the adhesive coating is exposed along the fastener portion.

6. The adhesive label of claim 4 wherein the backing layer includes a release layer disposed between the front cover portion and the backing layer.

7. The adhesive label of claim 6 wherein the release layer interacts with the adhesive layer to impart a curvature to the backing material and the substrate.

8. (canceled)

9. The adhesive label of claim 1 wherein the front cover portion and the back cover portion are disposed in a single plane such that the front cover portion and the back cover portion are simultaneously printable utilizing a single printing process.

10. The adhesive label of claim 1 wherein the substrate further includes a perforation extending between the front cover portion and the back cover portion along the edge.

11. An adhesive label comprising:
a substrate comprising:
a first side having an adhesive coating; and
a second side having printed information;
wherein the substrate is shaped to form a back cover and a front cover, the front cover having a larger surface area than the back cover; and
a backing comprising:
a first side releasably engaged with the adhesive coating; and
a die cut extending through the backing to define a reinforcement layer positioned adjacent only the front cover;
wherein the back cover of the substrate is foldable around the reinforcement layer to define a double-sided label comprising a double layer of substrate and a single layer of backing.

12. The adhesive label of claim 11 wherein the backing further comprises an expendable portion outside of a perimeter of the die cut such that when the expendable portion is removed from the backing, the adhesive coating on the back cover is exposed.

13. The adhesive label of claim 14 wherein the die cut extends through the backing to form a pair of integral tabs along an outer periphery of the reinforcement layer such that the tabs extend beyond the top cover and the back cover when folded along the perforation.

14. The adhesive label of claim 11 wherein the substrate further comprises:
a perforation extending between the front cover and back cover;
wherein the substrate is foldable along the perforation.

15. The adhesive label of claim 14 wherein the front cover and the back cover include customized information imprinted on the substrate through a retail printing process.

16. The adhesive label of claim 15 wherein the front cover and back cover are coplanar.

17. The adhesive label of claim 18 wherein the back cover is folded to be adjacent the reinforcement layer, and the reinforcement layer is unfolded.

18. The adhesive label of claim 13 wherein the front cover includes a hinge portion adjacent a first edge of the reinforcement layer and a fastener portion adjacent a second edge of the reinforcing portion extending over and between the pair of tabs.

19. A method for forming a double-sided, customized adhesive label, the method comprising:
fabricating a planar backing layer having a release layer;
affixing a planar substrate to the backing, the substrate comprising:
an adhesive layer positioned between the release layer and the substrate; and
a cover portion having a first space for receiving customized imprinting;
a back portion having a second space for receiving customized imprinting;
printing customized indicia onto the first and second spaces;
removing the backing layer from the substrate; and
folding the substrate between the cover portion and the back portion such that the cover portion and the back portion are adhered to each other and the customized imprinting is positioned on front and back sides of the adhesive label.

20. The method of claim 19 wherein the backing layer includes a die cut extending through the backing layer to form a reinforcement portion adjacent only the cover portion, an expendable portion adjacent at least the back portion and a tab extending from the reinforcement portion.

21. The method of claim 20 wherein the step of removing the backing from the substrate further comprises removing the expendable portion such that the reinforcement portion remains adhered to the substrate and the tab extends beyond a periphery of the cover portion.

22. The method of claim 21 wherein the reinforcement portion is positioned against the adhesive layer alongside the cover portion such that a hinge portion and a fastener portion are formed on opposite sides of the cover portion, the fastener portion extending over a portion of the tab.

23. The method of claim 21 wherein the substrate includes a perforation positioned between the cover portion and the back portion and the substrate is folded along the perforation such that reinforcement portion is positioned between and adhered to the cover portion and the back portion.

24. An adhesive label comprising:
a substrate comprising:
a first portion comprising:
a first side printable by a printing process; and
a second side coated with an adhesive coating;
a second portion comprising:
a first side printable by the printing process; and
a second side coated with the adhesive coating; and
a reinforcement layer positioned between the first portion and the second portion, the reinforcement layer having a front side and a back side;
wherein the second side of the first portion is adhered to the front side of the reinforcement layer and the second side of the second portion is adhered to the back side of the reinforcement layer to leave a segment of the second side of the first portion exposed.

25. The adhesive label of claim 18 wherein the perforation is positioned within an outer periphery of the back cover such the adhesive layer adheres to both the reinforcement layer and itself when folded along the perforation.
